(19) United States
(12) Patent Application Publication
(10) Pub. No.: US 2010/0307226 A1
(43) Pub. Date: Dec. 9, 2010

(54) APPARATUS, KITS AND METHODS FOR DETERMINING THE PRESENCE OR ABSENCE OF MINERALOCORTICOIDS IN SAMPLES

(75) Inventors: Donald Peter Cooper, Macclesfield (GB); Michael Morris, Glossop (GB); Paul James Taylor, Queensland (AU)

Correspondence Address: Waters Technologies Corporation, 34 MAPLE STREET - LG, MILFORD, MA, 01757, US

(73) Assignee: WATERS TECHNOLOGIES CORPORATION, Milford, MA (US)

(21) Appl. No.: 12/743,281

(22) PCT Filed: Nov. 14, 2008
(86) PCT No.: PCT/US08/83559

§ 371 Date: Jul. 21, 2010

Related U.S. Application Data
(60) Provisional application No. 60/991,248, filed on Nov. 30, 2007.

(51) Int. Cl. G01N 30/00; H01J 49/26

(52) U.S. Cl. 73/61.52; 250/281

(57) ABSTRACT

Embodiments of the present invention feature apparatus, kits and methods for detecting the presence or absence of a mineralocorticoid in biological samples. The methods, apparatus and kits feature a high performance liquid chromatography system with a column for receiving one or more biological samples potentially having mineralocorticoid, said chromatography system receiving one or more biological samples at a first time and separating the compounds in retained peaks comprising at least mineral corticoid retained peak for a mineralocorticoid in the event said mineralocorticoid is present at a mineralocorticoid retention time. And, a mass spectrometer in fluid communication with the high performance liquid chromatography system receives one or more of said retained peaks including the mineralocorticoid retained peak at the mineralocorticoid retention time, and produces a signal to allow said mineralocorticoid to be identified by retention peak and mass charge values.

### CROSS REFERENCE TO RELATED APPLICATIONS

This application claims benefit of priority to U.S. Ser. No. 60/991,248 filed February Nov. 30, 2007, the entire contents of which is incorporated herein by reference.

### FIELD OF THE INVENTION

Embodiments of the present invention relate to determining the presence or absence of mineralocorticoids, such as aldosterone, in biological samples.

### BACKGROUND OF THE INVENTION

The accurate measurement of circulating mineralocorticoids, such as aldosterone concentrations, is essential for the correct diagnosis of mineralocorticoid disorders. Primary aldosteronism (PAL) is caused by elevated levels of aldosterone and results in high blood pressure and fluid retention.

As used herein the term “mineralocorticoid” refers to a steroid hormone having an effect on salt and water balance. Aldosterone and cortisol are important mineralocorticoids. The term aldosterone is a used in the normal chemical sense as referring to the steroid having a four ring structure, three rings having a six members and one having five members having a formula C₂₁H₂₈O₅, as set forth in formula 1 below:

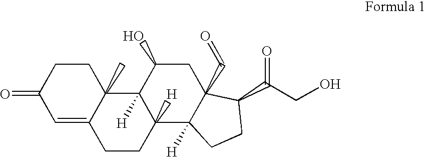

The term “cortisol” is used in a normal chemical sense as referring to the steroid having a four ring structure, three rings having six members and one ring having five members, having a formula C₂₁H₃₀O₅, as set forth in FIG. 2 below:

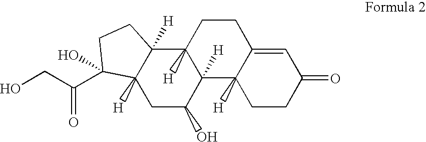

The current mainstay for measuring aldosterone is by antibody based methods. These immunoassays are limited by variable selectivity and poor inter-laboratory reproducibility requiring each laboratory to establish their own reference range for the diagnosis of PAL. Methods, kits and apparatus to determine aldosterone in biological fluids such as blood, plasma, urine and the like for both screening and confirmation of PAL and other disorders are desired.

### SUMMARY OF THE INVENTION

Embodiments of the present invention are directed to the detecting the presence or absence of a mineralocorticoid in biological samples. One embodiment of the present invention is directed to an apparatus having a high performance liquid chromatography system with a column for receiving one or more biological samples potentially having mineralocorticoid. The chromatography system receives one or more biological samples at a first time and separates the compounds in retained peaks comprising at least mineralocorticoid retained peak, in the event said mineralocorticoid is present, at a mineralocorticoid retention time. The apparatus further comprises a mass spectrometer in fluid communication with the high performance liquid chromatography system to receive one or more of the retained peaks including the mineralocorticoid retained peak at the mineralocorticoid retention time. The mass spectrometer produces a signal in the presence of the mineralocorticoid at the retention time to allow the mineralocorticoid to be identified by retention peak and mass charge values.

As used herein, the term “biological sample” urine, blood, plasma cerebral spinal fluid and the like. The biological fluid may be processed or applied directly to the high performance chromatography system. A preferred sample is processed to remove cellular material and large proteins. A preferred sample may concentrate the mineralocorticoid. A more concentrated mineralocorticoid sample can be made by forming a complex between such mineralocorticoid and an antibody or fragment of an antibody. The antibody can be immobilized on a support or further isolated by filtration or precipitation. The mineralocorticoid can be released from the antibody complex by salt or pH adjustments to solutions in which the complex is held.

The term “high performance liquid chromatography system” refers to a system for performing chromatography under pressure through a column or high pressure cartridge. This paper will use the term column to refer to columns and high pressure cartridges and will use the term cartridge to denote low pressure devices often used for preparing a sample for analytical processes.

The apparatus is, in one aspect, used to determine the presence or absence of the mineralocorticoid, aldosterone.

Preferably, the apparatus further has data management means. As used herein, the term “data management means” refers to a computer processing unit (CPU), personal computer, mainframe computer, server, or instrument controls such as a instrument CPU with appropriate software. One aspect of the invention features such data management means receiving the one or more mass charge values and retention times and identifying signals which correspond to the mineralocorticoid.

One preferred data management system compares the signal identifying said mineralocorticoid with control values to determine a concentration said mineralocorticoid in said biological sample. One preferred data management system produces a warning signal indicating concentration values of mineralocorticoid in the biological sample which are outside normal values. This warning can be a numerical concentration value that exceeds the normal value or a highlighted value or symbol. The abnormal value, if excessive, or warning signal is an indicator of primary aldosteronism where the mineralocorticoid is aldosterone.

One aspect of the apparatus features a column packed with a media of 2-10 micron particles. A preferred particle is silica or organic with silane sometimes referred to in the art as a hybrid particle. A preferred particle has a aliphatic group bonded to the surface of the particle. According to the present invention, the term “aliphatic group” includes organic moieties characterized by straight or branched-chains, typically having between 1 and 30 carbon atoms, cyclic alkyl and alkenes and aromatics. In complex structures, the chains may be branched, bridged, or cross-linked. Aliphatic groups include alkyl groups, alkenyl groups, and alkynyl groups.

Alkyl groups include saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or cycloalkyl or alicyclic groups) (e.g., cyclopropyl, cyclopentyl, cyclohexyl, cycloheptyl, cyclooctyl, etc.), branched-chain alkyl groups (isopropyl, tert-butyl, sec-butyl, isobutyl, etc.), and alkyl-substituted alkyl groups (e.g., alkyl-substituted cycloalkyl groups and cycloalkyl-substituted alkyl groups).

In certain embodiments, a straight-chain or branched-chain alkyl group may have 30 or fewer carbon atoms in its backbone, e.g., C₁-C₃₀ for straight-chain or C₃-C₃₀ for branched-chain. In certain embodiments, a straight-chain or branched-chain alkyl group may have 20 or fewer carbon atoms in its backbone, e.g., C₁-C₂₀ for straight-chain or C₃-C₂₀ for branched-chain, and more preferably 18 or fewer. Likewise, preferred cycloalkyl groups have from 4-10 carbon atoms in their ring structure, and more preferably have 4-7 carbon atoms in the ring structure. The term “lower alkyl” refers to alkyl groups having from 1 to 6 carbons in the chain, and to cycloalkyl groups having from 3 to 6 carbons in the ring structure.

Unless the number of carbons is otherwise specified, “lower” as in “lower aliphatic,” “lower alkyl,” “lower alkenyl,” etc. as used herein means that the moiety has at least one and less than about 8 carbon atoms. In certain embodiments, a straight-chain or branched-chain lower alkyl group has 6 or fewer carbon atoms in its backbone (e.g., C₁-C₆ for straight-chain, C₃-C₆ for branched-chain), and more preferably 4 or fewer. Likewise, preferred cycloalkyl groups have from 3-8 carbon atoms in their ring structure, and more preferably have 5 or 6 carbons in the ring structure. The term “C₁-C₆” includes alkyl groups containing 1 to 6 carbon atoms.

Moreover, unless otherwise specified the term alkyl includes both “unsubstituted alkyls” and “substituted alkyls,” the latter of which refers to alkyl moieties having substituents replacing one or more hydrogens on one or more carbons of the hydrocarbon backbone. Such substituents can include, for example, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, sulfonato, sulfamoyl, sulfonamido, nitro, trifluoromethyl, cyano, azido, heterocyclyl, alkylaryl, or aromatic or heteroaromatic moieties.

An “arylalkyl” moiety is an alkyl group substituted with an aryl (e.g., phenylmethyl (i.e., benzyl)). An “alkylaryl” moiety is an aryl group substituted with an alkyl group (e.g., p-methylphenyl (i.e., p-tolyl)). The term “n-alkyl” means a straight-chain (i.e., unbranched) unsubstituted alkyl group. An “alkylene” group is a divalent moiety derived from the corresponding alkyl group. The terms “alkenyl” and “alkynyl” refer to unsaturated aliphatic groups analogous to alkyls, but which contain at least one double or triple carbon-carbon bond respectively. Suitable alkenyl and alkynyl groups include groups having 2 to about 12 carbon atoms, preferably from 1 to about 6 carbon atoms. A “vinyl” group is an ethylenyl group (i.e., —CH═CH₂). A “styryl” group is a vinyl-substituted phenyl group.

The term “aromatic group” includes unsaturated cyclic hydrocarbons containing one or more rings. Aryl groups can also be fused or bridged with alicyclic or heterocyclic rings which are not aromatic so as to form a polycycle (e.g., tetralin). The term “aromatic group” includes unsaturated cyclic hydrocarbons containing one or more rings. In general, the term “aryl” includes groups, including 5- and 6-membered single-ring aromatic groups that may include from zero to four heteroatoms, for example, groups derived from benzene, pyrrole, furan, thiophene, thiazole, isothiaozole, imidazole, triazole, tetrazole, pyrazole, oxazole, isooxazole, pyridine, pyrazine, pyridazine, and pyrimidine, and the like. An “arylene” group is a divalent moiety derived from an aryl group. The term “heterocyclic group” includes closed ring structures in which one or more of the atoms in the ring is an element other than carbon, for example, nitrogen, sulfur, or oxygen. Heterocyclic groups can be saturated or unsaturated and heterocyclic groups such as pyrrole and furan can have aromatic character. They include fused ring structures such as quinoline and isoquinoline. Other examples of heterocyclic groups include pyridine and purine. Heterocyclic groups can also be substituted at one or more constituent atoms

The term “amino,” as used herein, refers to an unsubstituted or substituted moiety of the formula —NR^{a}R^{b}, in which R^{a} and R^{b} are each independently hydrogen, alkyl, aryl, or heterocyclyl, or R^{a} and R^{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. Thus, the term “alkylamino” as used herein means an alkyl group, as defined above, having an amino group attached thereto. Suitable alkylamino groups include groups having 1 to about 12 carbon atoms, preferably from 1 to about 6 carbon atoms. The term “alkylthio” refers to an alkyl group, as defined above, having a sulfhydryl group attached thereto. Suitable alkylthio groups include groups having 1 to about 12 carbon atoms, preferably from 1 to about 6 carbon atoms. The term “alkylcarboxyl” as used herein means an alkyl group, as defined above, having a carboxyl group attached thereto. The term “alkoxy” as used herein means an alkyl group, as defined above, having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like. The term “nitro” means —NO₂; the term “halogen” or “halo” designates —F, —Cl, —Br or —I; the term “thiol,” “thio,” or “mercapto” means SH; and the term “hydroxyl” or “hydroxyl” means —OH.

Unless otherwise specified, the chemical moieties of the compounds of the invention, including those groups discussed above, may be “substituted or unsubstituted.” In some embodiments, the term “substituted” means that the moiety has substituents placed on the moiety other than hydrogen (i.e., in most cases, replacing a hydrogen) which allow the molecule to perform its intended function. Examples of substituents include moieties selected from straight or branched alkyl (preferably C₁-C₅), cycloalkyl (preferably C₃-C₈), alkoxy (preferably C₁-C₆), thioalkyl (preferably C₁-C₆), alkenyl (preferably C₂-C₆), alkynyl (preferably C₂-C₆), heterocyclic, carbocyclic, aryl (e.g., phenyl), aryloxy (e.g., phenoxy), aralkyl (e.g., benzyl), aryloxyalkyl phenyloxyalkyl), arylacetamidoyl, alkylaryl, heteroaralkyl, alkylcarbonyl and arylcarbonyl or other such acyl group, heteroarylcarbonyl, or heteroaryl group, (CR′R″)₀₋₃NR′R″ (e.g., —NH₂), (CR′R″)₀₋₃CN (e.g., —CN), NO₂, halogen (e.g., F, Cl, Br, or I), (CR′R″)₀₋₃C(halogen)₃ (e.g., —CF₃), (CR′R″)₀₋₃CH(halogen)₂, (CR′R″)₀₋₃CH₂(halogen), (CR′R″)₀₋₃CONR′R″, (CR′R″)₀₋₃(CNH)NR′R″, (CR′R″)₀₋₃S(O)₁₋₂NR′R″, (CR′R″)₀₋₃CHO, (CR′R″)₀₋₃O(CR′R″)₀₋₃H, (CR′R″)₀₋₃S(O)₀₋₃R′ (e.g., —SO₃H), (CR′R″)₀₋₃O(CR′R″)₀₋₃H (e.g., —CH₂OCH₃ and —OCH₃), (CR′R″)₀₋₃S(CR′R″)₀₋₃H (e.g., —SH and —SCH₃), (CR′R″)₀₋₃OH (e.g., —OH), (CR′R″)₀₋₃COR′, (CR′R″)₀₋₃(substituted or unsubstituted phenyl), (CR′R″)₀₋₃(C₃-C₈ cycloalkyl), (CR′R″)₀₋₃CO₂R′ (e.g., —CO₂H), or (CR′R″)₀₋₃OR′ group, or the side chain of any naturally occurring amino acid; wherein R′ and R″ are each independently hydrogen, a C₁-C₅ alkyl, C₂-C₅ alkenyl, C₂-C₅ alkynyl, or aryl group, or R′ and R″ taken together are a benzylidene group or a —(CH₂)₂O(CH₂)₂— group.

A “substituent” as used herein may also be, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety.

A preferred aliphatic group is an alkyl chain of six to eighteen carbons in length.

A preferred apparatus has a high pressure chromatography system that is operated isocratically, with 30-40% acetonitrile in water.

Preferably, the biological sample is spiked with a known amount of labelled mineralocorticoid derivative. The chromatography system produces a labelled mineralocorticoid peak which is used to compare the mineralocorticoid peak to allow the concentration of the retained mineralocorticoid to be more readily determined.

A further embodiment of the present invention is directed to a kit for determining the concentration of mineralocorticoid in biological samples. As used herein, the term “kit” refers to an assembly of parts and reagents for use in performing processes defined in instructions. One embodiment of the present kit features labelled mineralocorticoid and instructions for the use in processes with a high performance liquid chromatography system and a mass spectrometer to determine the presence or absence of elevated levels of mineralocorticoid.

For example, without limitation, one embodiment of the present invention features a mineralocorticoid, aldosterone, which kit has a labelled aldosterone. As used herein, the term “labelled” refers to a chemical moiety or functional group that reacts with the mineralocorticoid with high efficiency and allows the labelled mineralocorticoid to be readily identified in mass spectra data. A preferred label is an aliphatic group.

Preferably, the kit further comprises other consumable components and goods used in performing the processes. For example, without limitation, one embodiment of the present invention further comprises a column.

A further embodiment of the present invention features a method of determining the presence or absence of a mineralocorticoid in a biological sample. The method comprising the steps of placing a biological sample in a high performance liquid chromatography system having a column. The high performance liquid chromatography system is for receiving one or more biological samples potentially having a mineralocorticoid. The chromatography system receives the biological sample at a first time and separates the compounds in retained peaks comprising at least one mineralocorticoid retained peak, in the event the mineralocorticoid is present, at a mineralocorticoid retention time. The method further comprises the step of placing the at least one retained peak corresponding with a retention time for mineralocorticoid in a mass spectrometer in fluid communication with the high performance liquid chromatography system. The mass spectrometer receives the at least one retained peak, including said mineralocorticoid retained peak, at the mineralocorticoid retention time, if said mineralocorticoid is present in the biological sample. And, the mass spectrometer produces a signal in the presence of the mineralocorticoid at said retention time to allow the mineralocorticoid to be identified by retention peak and mass charge values.

Preferably, the signal is received by data management means. The data management means receives the one or more mass charge values and retention times and identifies signals which correspond to the mineralocorticoid. One embodiment of the present method features the mineralocorticoid, aldosterone.

Preferably, the data management system compares the signals identifying a mineralocorticoid with control values to determine a mineralocorticoid concentration in said biological sample.

Preferably, the method further comprises the step of providing a derivative of the mineralocorticoid in the biological sample. The derivative provides a labelled mineralocorticoid and the chromatography system produces a labelled mineralocorticoid peak to provide a control value. Preferably, the mineralocorticoid retained peak is compared to the labelled mineralocorticoid peak to allow the concentration of the retained mineralocorticoid to be compared to the labelled mineralocorticoid peak.

Preferably, the method comprises the step of producing a warning signal indicating concentration values of mineralocorticoid in the biological sample which are outside normal values. This step is preferably performed by the date management system. The warning signal, where the mineralocorticoid is aldosterone, is an indicator of primary aldosteronism.

Embodiments of the present method feature a column has a packed media of 2-10 micron particles. Preferably, the particles have a carbon functionality. Embodiments of the present method feature a high pressure chromatography system operated isocratically. A preferred solvent is 30-40% acetonitrile in water.

Embodiments of the present invention feature sample preparation with antibodies to the mineralocorticoid. The antibodies form an antibody-mineralocorticoid complex. The complex is isolated by immobilization prior to or after forming the complex. Or, the complex is isolated by filtration or precipitation. The mineralocorticoid is released from the antibody complex by changes in the salt or pH conditions of the solutions in which the complex is held.

These and other features and advantages will be apparent to those skilled in the art upon reading the text of the detailed description and reviewing the drawing which are briefly described below.

### BRIEF DESCRIPTION OF THE DRAWINGS

FIG. 1 depicts in schematic form an apparatus embodying features of the present invention.

FIG. 2 depicts a kit embodying features of the present invention.

FIG. 3(A) is a graphical depiction of the retention profile of compounds eluting from a column derived from a Addison's Patient Sample.

FIG. 3(B) is a graphical depiction of the lower limit of quantification of a sample.

FIG. 3(C) is a graphical depiction of a retention profile of a patient sample.

FIG. 4 is a graphical depiction of a retention profile of a patient sample.

FIG. 4 is a bar graph depicting the frequency distribution of aldosterone results obtained from seated normal tensive subjects.

FIG. 5 depicts graphically aldosterone concentration from plain clot versus EDTA collection tubes.

FIG. 6 depicts graphically a comparison of results at various aldosterone concentrations obtained by apparatus embodying features of the present invention with DPC immunoassay.

FIG. 7 depicts comparison of aldosterone concentrations measured using plasma or aqueous calibrators for 131 patient samples.

FIGS. 8A & 8B depicts a chromatograph of cortisol and aldosterone.

### DETAILED DESCRIPTION OF THE INVENTION

Embodiments of the present invention will be described in detail as apparatus, kits and methods for detecting the presence or absence of a mineralocorticoid in biological samples. Embodiments further feature the quantification of mineralocorticoids in samples as a diagnostic tool. The following description details what is now understood as the preferred embodiments of the present invention with the understanding that the invention may be altered and modified by those skilled in the art for other applications and uses without departing from the teaching presented herein.

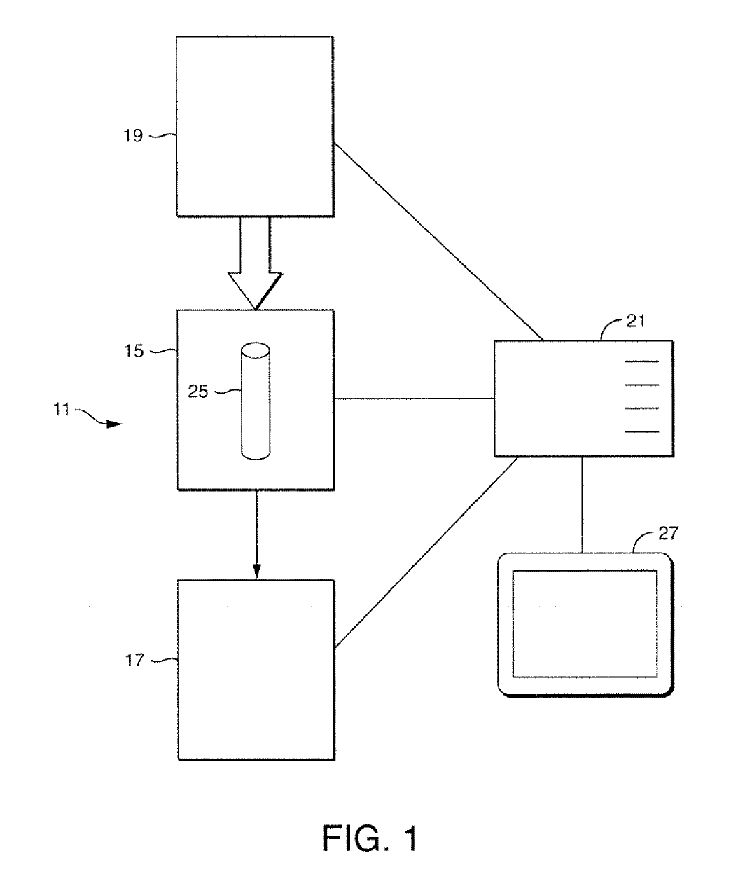

An apparatus embodying features of the present invention, generally depicted in schematic form, generally designated by the numeral 11, is shown in FIG. 1. The apparatus has the following major elements: a high performance liquid chromatography system 15, a mass spectrometer 17, a sample preparation assembly 19 and a data management system 21.

High performance liquid chromatography (HPLC) systems 15 are known in the art and are available from numerous vendors. For example, without limitation, HPLC systems 15 are sold under the trademarks ALLIANCE® and ACQUITY® (Waters Corporation, Milford, Mass., USA). HPLC systems are sold as integrated systems of pumps, injectors and sample handling hardware or as separate modules. The sample handling hardware receives vials loaded with samples. The injector withdraws the sample and places the sample in the fluid lines of the HPLC system. These details are known to those skilled in the art and are omitted from the drawings for clarity. A preferred HPLC system 25 is operated isocratically, with 30-40% acetonitrile in water.

The HPLC system has a column 25. The column 25 is in communication with the pumps and injectors for receiving one or more biological samples potentially having mineralocorticoid. The column 25 of the chromatography system receives one or more biological samples at a first time and separates the compounds into retained peaks comprising at least mineralocorticoid retained peak, in the event said mineralocorticoid is present, at a mineralocorticoid retention time. One aspect of the apparatus features a column packed with a media of 2-10 micron particles. A preferred particle is silica or organic with silane sometimes referred to in the art as a hybrid particle. A preferred particle has an aliphatic group bonded to the surface of the particle. According to the present invention, the term “aliphatic group” includes organic moieties characterized by straight or branched-chains, typically having between 1 and 30 carbon atoms, cyclic alkyl and alkenes and aromatics. In complex structures, the chains may be branched, bridged, or cross-linked. Aliphatic groups include alkyl groups, alkenyl groups, and alkynyl groups.

A preferred aliphatic group is an alkyl chain of six to thirty carbons in length. Columns 25 are available from numerous venders; for example, without limitation, one column 25 is sold under the trademark SUNFIRE® with a aliphatic group, C18, surface chemistry and 3 micron particle size (Waters Corporation, Milford, Mass., USA).

The apparatus 11 further comprises a mass spectrometer 17 in fluid communication with the high performance liquid chromatography system 15 to receive sample, now separated into one or more retained peaks. Each retained peak will have an associated retention. For the purpose of this discussion, the retained peak associated with the mineralocorticoid of interest will be referred to as the mineralocorticoid retained peak having a mineralocorticoid retention time.

The mass spectrometer 17 produces a signal in the presence of the mineralocorticoid at the retention time to allow the mineralocorticoid to be identified by retention peak and mass charge values. Mass spectrometers, such as mass spectrometer 17, are available from numerous venders. One such mass spectrometer, a triple quadrupole, is sold under the trademark QUATTRO PREMIER™ (Waters Corporation. Milford, Mass., USA)

As used herein, the term “biological sample” urine, blood, plasma cerebral spinal fluid and the like. The biological fluid may be processed or applied directly to the high performance chromatography system. As depicted, the apparatus comprises a sample preparation system 19 to remove cellular material and large proteins. Sample preparation systems 19 are sold by numerous venders. One such sample preparation system is sold under the trademark SYMBIOSIS® (Spark Holland, Emmen Holland) as an on-line system. This system operates with extraction cartridges available from several venders. A preferred cartridge is sold under the trademark HYSPHERE™ with an aliphatic, C18, surface chemistry (Spark Holland, Emmen, Holland).

A preferred sample may concentrate the mineralocorticoid. A more concentrated mineralocorticoid sample can be made by forming a complex between such mineralocorticoid and an antibody or fragment of an antibody. The antibody can be immobilized on a support or further isolated by filtration or precipitation. The mineralocorticoid can be released from the antibody complex by salt or pH adjustments to solutions in which the complex is held.

As depicted, the sample preparation assembly 19 is in mechanical or fluid communication with the HPLC system 15 by the double arrow. The term “fluid communication” means plumbed together as in linked by pipes, or conduits. The term “mechanical communication” means capable of passing fluid in vials or in such close proximity as to allow the fluids to be moved readily from one component to another. The HPLC system 15 is shown in fluid communication with the mass spectrometer 17 by a solid line.

The HPLC system 25, mass spectrometer 17 and, preferably, the sample preparation assembly 19 are in signal communication with the data management system 21. As used herein, the term “signal communication” refers to electronic or radio or optical communication, such as wireless communications to pass data and instrument commands.

Apparatus 11 has data management means 21, depicted in FIG. 1 as a computer with a display screen 27. However, data management means may take many forms, such as, a computer processing unit (CPU), personal computer, mainframe computer, server, or instrument controls such as an instrument CPU with appropriate software. Computers and software are available from several venders. Software programs are sold under the trademarks EMPOWER™ and MASSLINX® (Waters Corporation, Milford, Mass., USA).

Data management means 21 receives one or more mass charge values and retention times and identifies signals which correspond to the mineralocorticoid. Preferably, the data management system 21 compares the signal identifying said mineralocorticoid with control values to determine a concentration said mineralocorticoid in said biological sample. A preferred data management system 21 produces a warning signal indicating concentration values of mineralocorticoid in the biological sample which are outside normal values. This warning can be a numerical concentration value that exceeds the normal value or a highlighted value or symbol.

The abnormal value, if excessive, or warning signal is an indicator of primary aldosteronism where the mineralocorticoid is aldosterone. The warning signal is displayed on screen 27 or printed on paper copy [not shown]. The value may be stored in the memory [not shown] or communicated to other locations and computers.

Preferably, the biological sample is spiked with a known amount of labelled mineralocorticoid derivative. Thus, the sample preparation assembly 19 provides for the addition of a labelled mineralocorticoid derivative. The HPLC system 15 produces a labelled mineralocorticoid peak which is used to compare the mineralocorticoid peak. This comparison, performed by the data management system 21 allow the concentration of the retained mineralocorticoid to be more readily determined.

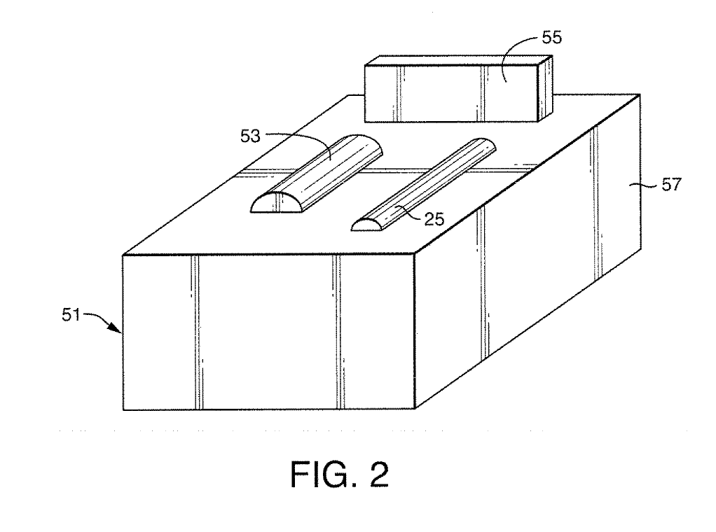

Turning now to FIG. 2, a further embodiment of the present invention is directed to a kit, generally designated by the numeral 51, for determining the concentration of mineralocorticoid in biological samples. The kit 51 is an assembly of parts and reagents for use in performing processes defined in instructions. Thus, kit 51 has labelled mineralocorticoid in vial 53, column 25 and instructions 55 for the use in processes with a high performance liquid chromatography system and a mass spectrometer to determine the presence or absence of elevated levels of mineralocorticoid. The kit 51 is held together by suitable packaging such as box 57.

Embodiment of the method of the present invention are discussed as to the operation of the apparatus 11 of FIG. 1. A biological sample is processed by sample preparation assembly 19. The processed biological sample is then placed in a high performance liquid chromatography system 15 having a column 25. The high performance liquid chromatography system 15 receives the biological samples at a first time and separates the compounds in retained peaks comprising at least one mineralocorticoid retained peak, in the event the mineralocorticoid is present, at a mineralocorticoid retention time. The sample of the at least one retained peak corresponding with a retention time for mineralocorticoid is placed in a mass spectrometer 17 in fluid communication with the high performance liquid chromatography system 15. The mass spectrometer receives 17 the at least one retained peak, including said mineralocorticoid retained peak, at the mineralocorticoid retention time, if said mineralocorticoid is present in the biological sample. And, the mass spectrometer 17 produces a signal in the presence of the mineralocorticoid at said retention time to allow the mineralocorticoid to be identified by retention peak and mass charge values.

The signal is received by data management means 21. The data management means receives the one or more mass charge values and retention times and identifies signals which correspond to the mineralocorticoid. The data management system 21 compares the signals identifying a mineralocorticoid with control values to determine a mineralocorticoid concentration in said biological sample.

Preferably, the method further comprises the step of providing a derivative of the mineralocorticoid in the biological sample. The derivative provides a labelled mineralocorticoid and the HPLC system 15 produces a labelled mineralocorticoid peak to provide a control value. Preferably, the mineralocorticoid retained peak is compared by the data management system 21 to the labelled mineralocorticoid peak to allow the concentration of the retained mineralocorticoid to be determined.

The data management system 21 produces a warning signal indicating concentration values of mineralocorticoid in the biological sample which are outside normal values.

The Examples that follow highlight features of the present invention.

### Example 1

### Materials and Methods

### Reagents

Aldosterone and d7-aldosterone (internal standard) were purchased from Sigma-Aldrich and IsoSciences (King of Prussia, Pa., USA), respectively. Stock solutions of aldosterone and internal standard were prepared in methanol. The calibrators and quality controls were prepared in EDTA plasma, obtained from patients with Addison's disease. The final calibrator concentrations were 25, 50, 100, 250, 500, 1000, and 2000 pg/mL. The concentrations of the quality controls were 25, 60, 400, 1500, and 2000 pg/mL. A quality control outside the analytical range (5000 pg/mL) was used for 1/5 and 1/10 dilution studies. A precipitation reagent was prepared with 0.3 M zinc sulphate:methanol (1:5, vol:vol) that contained internal standard (2950 pg/mL).

### Sample Preparation and On-Line Extraction

Plasma standards, quality controls and patient samples (200 μL) were pre-treated with precipitation reagent (200 μL), mixed and centrifuged. The supernatant was transferred to a Symbiosis HPLC-online solid phase extraction system (Spark Holland, Emmen, Holland). Hysphere C18 HD extraction cartridges (10×2 mm, 7 μm) were preconditioned with acetonitrile (1 mL) followed by water (1 mL) and loaded with the supernatant (250 μL). The cartridges were sequentially washed with 10% acetonitrile in 0.1% ammonium hydroxide (1 mL), 10% acetonitrile in 0.1% formic acid (1 mL) and 10% acetonitrile in water (1 mL). The analytes were washed from the cartridges under the initial chromatographic conditions (shown below) for 45 sec. The processing of samples was performed in parallel (i.e. while one sample is being prepared the previous is eluted). For more detail on the operation of the Symbiosis system see the recent article by de Jong et al (7).

### HPLC-Mass Spectrometry

Chromatography was performed on a Sunfire C18 analytical column (50×3.0 mm, 3 μm) under isocratic conditions (35% acetonitrile/water) at a flow rate of 0.3 mL/min. A column wash with 100% acetonitrile at 1 ml/min for 2 minutes was performed at 2.5 minutes after injection. The column was re-equilibrated at starting conditions for 2.5 minutes giving a total analysis time of 7 minutes.

Mass spectrometric detection was by selected reaction monitoring (aldosterone m/z 358.9→330.9; d7-aldosterone m/z 365.9→3337.9) using negative electrospray ionization conditions (−2500 V) on Quattro Premier triple quadrupole mass spectrometer (Waters Corp, USA). The compound specific operating parameters of cone voltage and collision energy were −30 V and −17 eV, respectively. The HPLC-MS was controlled and data processed by MassLynx (Waters).

### Results and Discussion

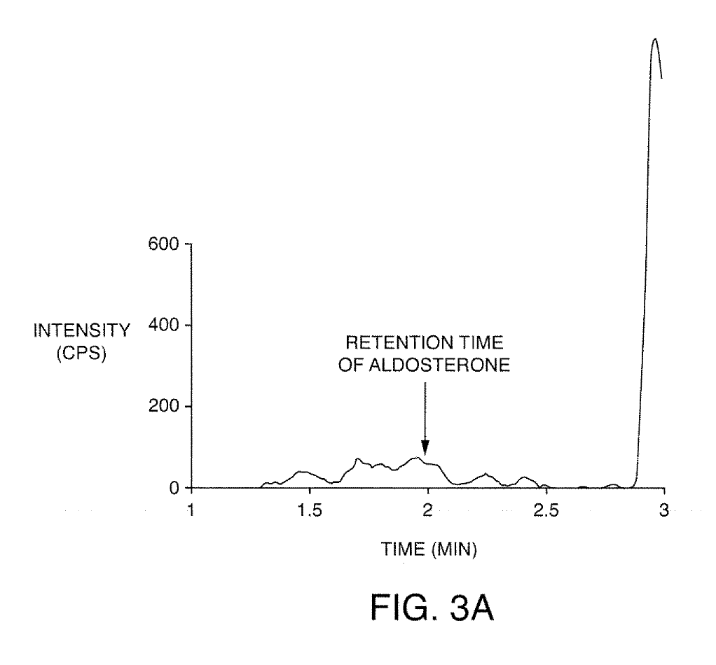

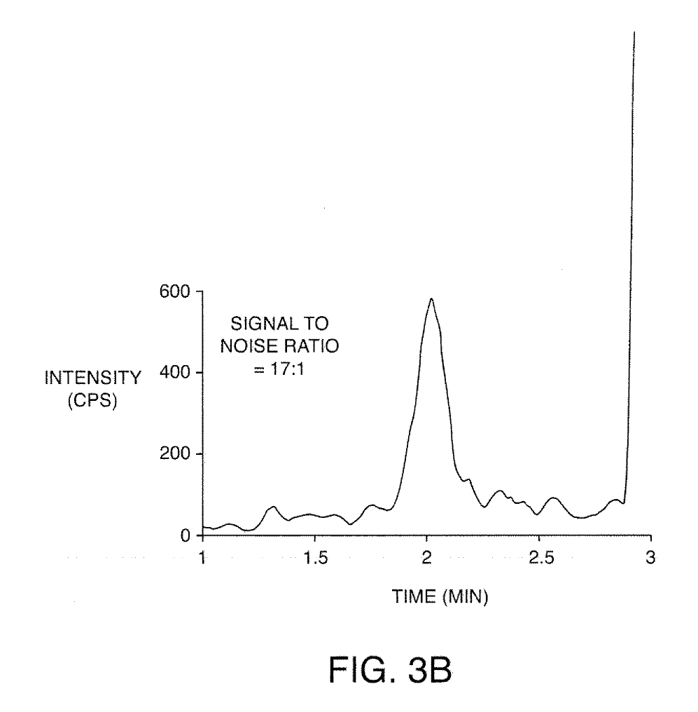

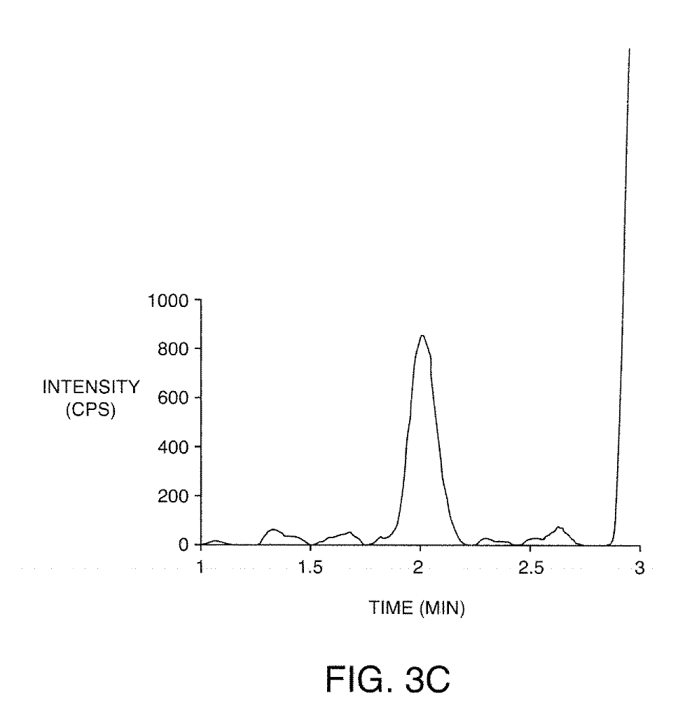

To illustrate the selectivity of the method, no interferences were observed when analyzing plasma from patients with Addison's disease (n=5). FIG. 3A shows an example chromatogram. Plasma obtained from these patients was sub sequentially used to make standards and quality controls.

The method was found to be linear over the analytical range of 25 to 2000 pg/mL (r2>0.996, n=8). Further, it was validated that samples with results above 2000 pg/mL could be successfully diluted 1/5 or 1/10. While most peripheral venous samples will be within the analytical range, a dilution protocol is required for some adrenal vein samples.

Table 1 shows that the inter- and intra-day accuracy and imprecision for quality control samples (60, 400, 1500 pg/mL) were 92.2 to 102% and <6.3%, respectively (n=5).

TABLE 1
The inter- and intra-day analytical recovery and imprecision of the
aldosterone HPLC-MS method (n = 5)

| | Nominal aldosterone | | | | |
|---|---|---|---|---|---|
| | concentration (pg/mL) | | | | |
| Parameter | 25 | 60 | 400 | 1500 | 2000 |
| Inter-day | | | | | |
| Analytical recovery | 94.5 | 96.4 | 96.4 | 97.7 | 99.5 |
| (%) | | | | | |
| Imprecision (%) | 9.4 | 5.0 | 2.7 | 2.1 | 3.4 |
| Intra-day | | | | | |
| Analytical recovery | 91.4 | 94.0 | 92.2 | 102 | 90.1 |
| (%) | | | | | |
| Imprecision (%) | 7.6 | 6.3 | 1.5 | 2.2 | 0.74 |

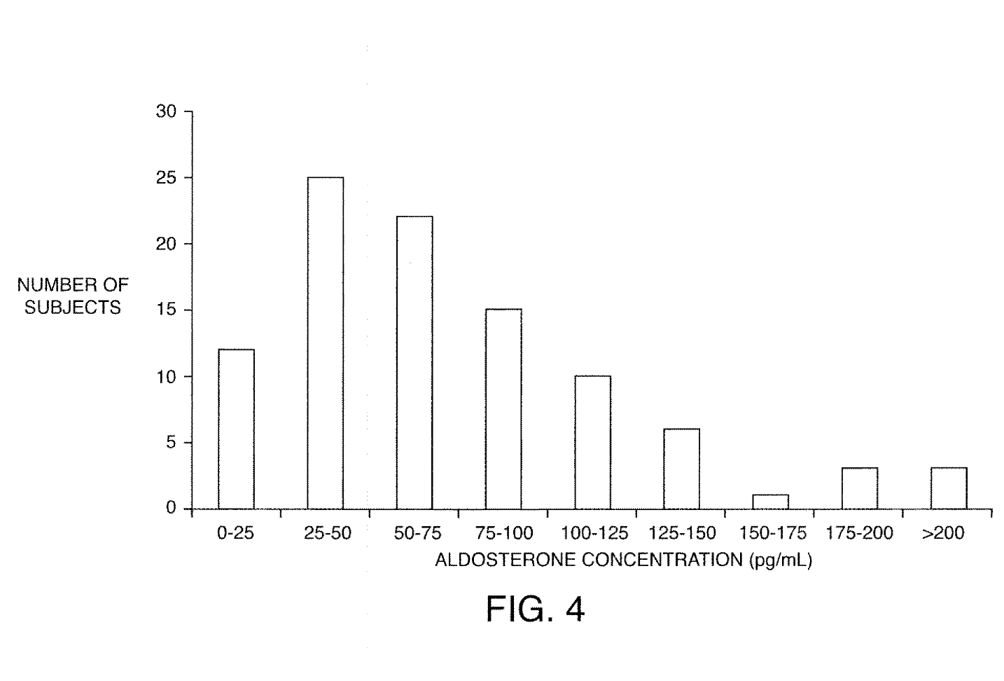

The lower limit of quantification was 25 pg/mL (FIG. 3B) with an inter- and intra-day accuracy and imprecision of 91.4 to 94.5% and <9.5% (n=5). The results of analysing a series of samples obtained from upright (seated) normotensive control subjects are shown in FIG. 4. The aldosterone concentrations and distribution of results was as expected for such a cohort. A chromatogram for a patient from this group is shown, in FIG. 3(C) (measured concentration of 52.7 pg/mL).

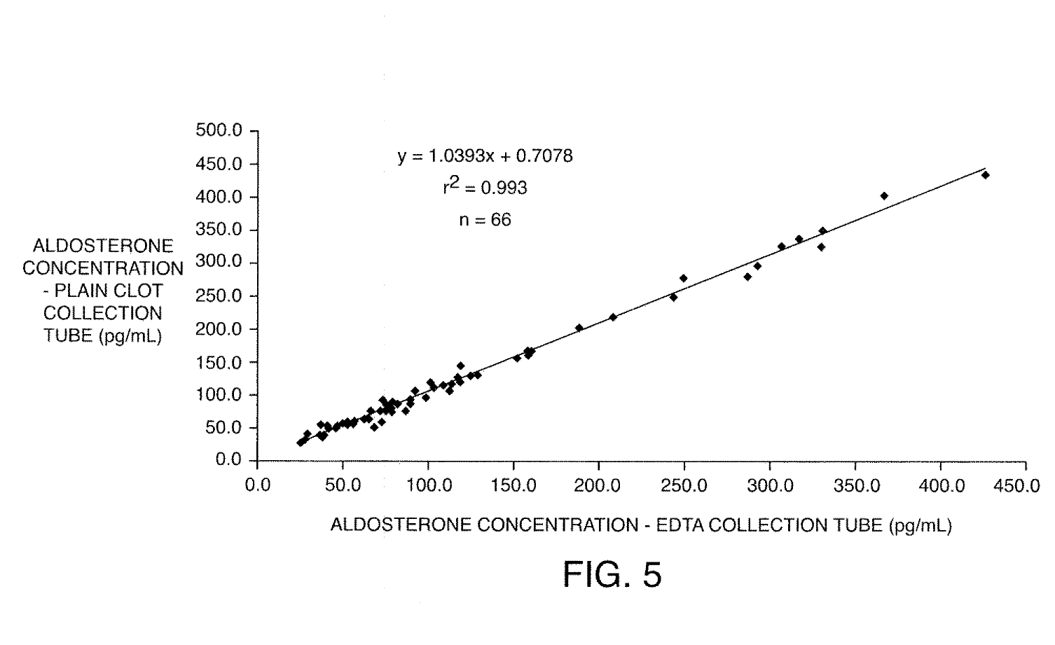

An evaluation of three other collection tubes (lithium heparin, plain clot and serum separator tube), using EDTA collection tubes as the reference revealed no significant differences in results. FIG. 5 shows a comparison of results for samples from plain clot tubes versus the EDTA tubes (r2=0.993, n=66).

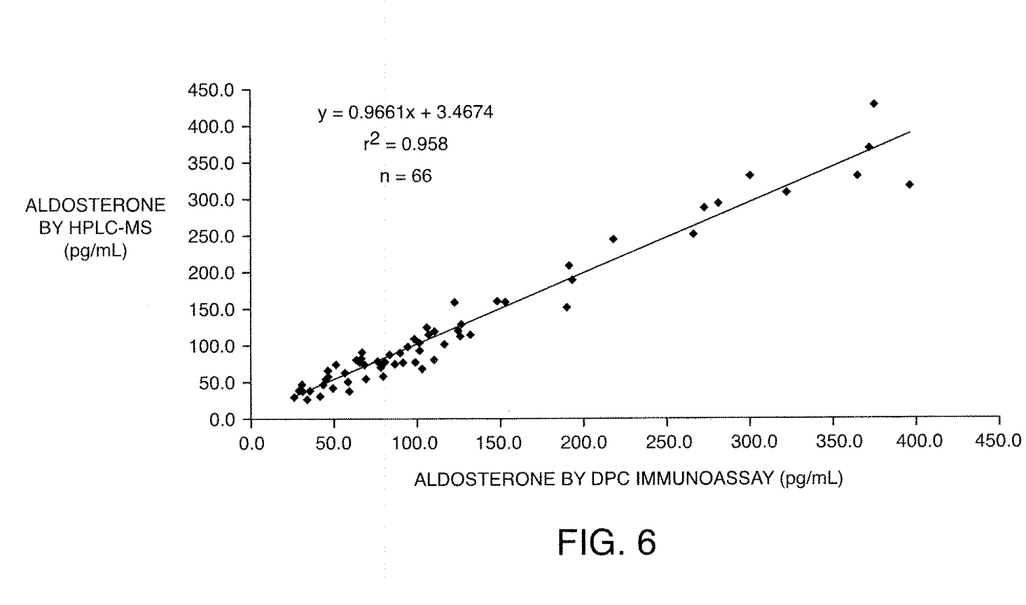

Aldosterone results obtained from the HPLC-MS method, for a series of 66 samples from patients undergoing fludrocortisone suppression tests, compared to those from an immunoassay (DPC Coat-a-Count™ aldosterone kit, Diagnostic Products Corporation, Los Angeles, Calif., USA) are shown in FIG. 6. Although there was fair agreement in the methods (r2=0.958) there was a large spread of results around the line of best fit. This spread was probably attributable to the imprecision of the immunoassay and/or non-specificity of the antibody.

Aldosterone concentrations in plasma samples obtained from two patients with congenital adrenal hyperplasia were measured by both HPLC-MS and DPC immunoassay. Results of these analyses were: 92.0 pg/mL (HPLC-MS) and 694 pg/mL (DPC) for Case 1 and 68.1 (HPLC-MS) and 303 pg/ml (DPC) for Case 2. These two cases illustrate, that under certain clinical conditions, immunoassays can suffer significantly from non-specific antibody binding that leads to overestimation in results and the potential for misdiagnosis.

The HPLC-MS method described here is accurate and precise across the clinically relevant range, provides a higher degree of selectivity than anti-body based methods and is not influenced by the type of sample analysed.

### Calibrators

Typically, a routine clinical assay requires the use of calibrators and QCs that are prepared in the same matrix as the analytes of interest. This is to ensure that any “matrix effects” that are not eliminated by the sample preparation have an approximately equal effect on the samples and on the calibrators and QCs so that the results of the sample analysis are accurate. Reference measurement procedures that employ extensive sample preparation and eliminate all apparent matrix effects are not influenced by the matrix in which the calibrators are prepared and can therefore use calibrators prepared in pure solvent eg water (1).

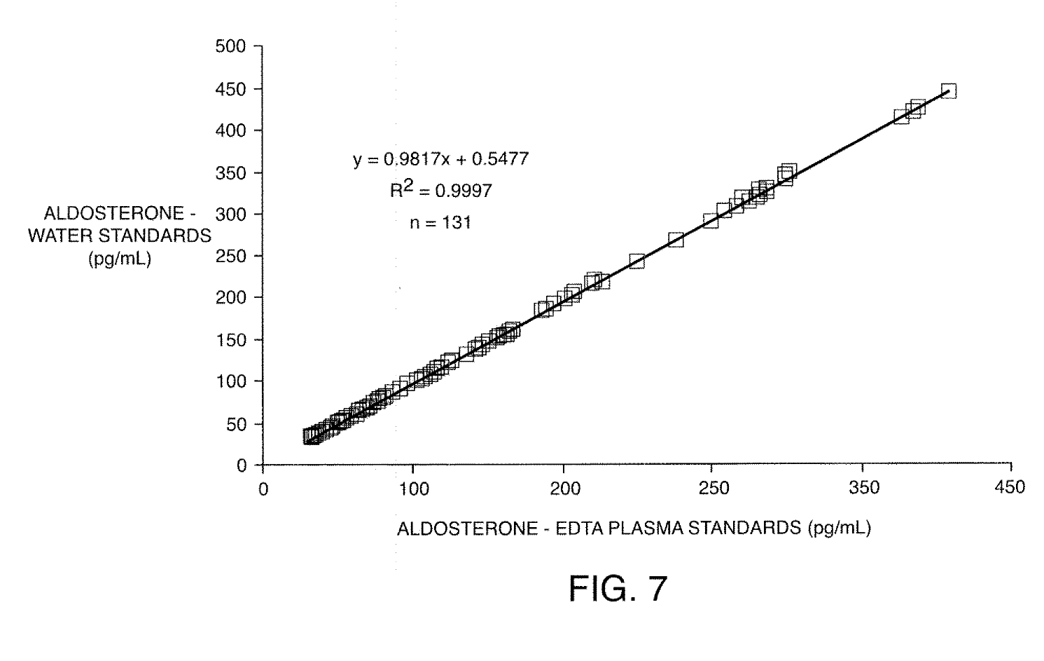

We have now compared the results obtained for the measurement of aldosterone using our on-line-SPE-LC/MS/MS method for 131 patient samples using calibrators prepared in matrix and calibrators prepared in water. When the two results for each sample are compared by way of linear regression analysis set forth in FIG. 7, there is a very strong correlation (r²=0.9997) and the slope of 0.982 indicates that on average, there is less than 2% difference between the results (calculated average mean difference is 1.24%). This is within experimental error and suggests that the on-line-SPE-LC/MS/MS method can be used in conjunction with non-matrix calibrators for the accurate analysis of patient samples. This will greatly simplify the manufacture of a reagent kit for the analysis of aldosterone and potentially other analytes and will also facilitate metrological traceability of the calibrators to international Standard Reference Materials such as those developed by NIST.

### Multiple Analytes

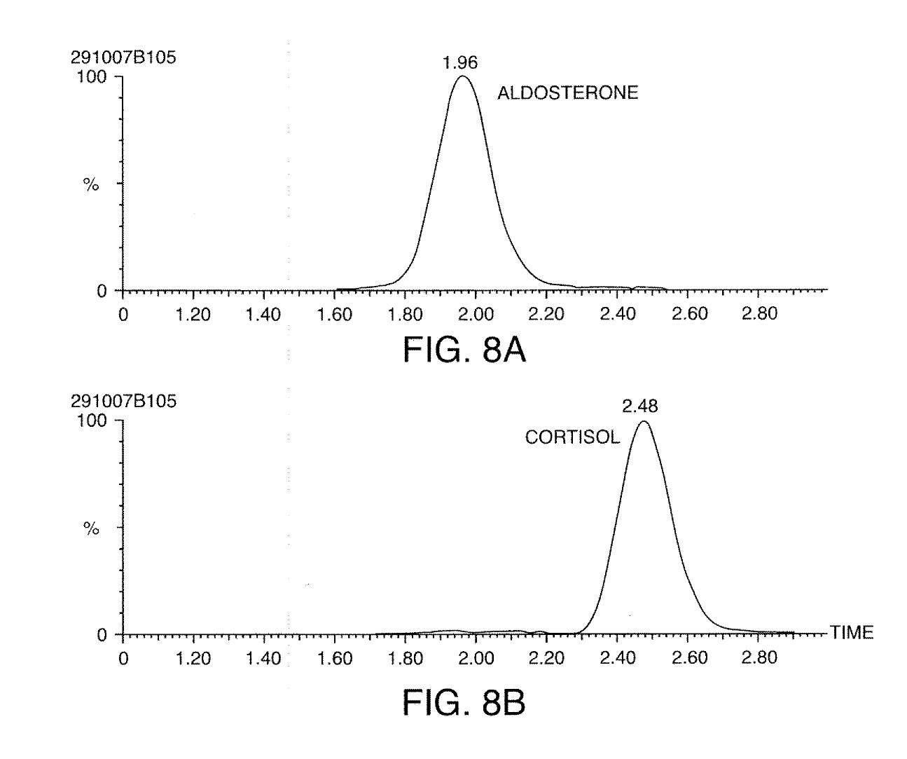

We have modified the LC/MS/MS conditions such that cortisol and aldosterone can be monitored and quantified simultaneously. An example chromatogram is below in FIG. 8.

Thus, we have described the present invention with the understanding that the description is of preferred embodiments and capable of modification and alteration. Therefore, the invention should not be limited to the precise details but should encompass the subject matter of the following claims and their equivalents.

What is claimed:

1. An apparatus for detecting the presence or absence of a mineralocorticoid in biological samples comprising:
a. a high performance liquid chromatography system with a column for receiving one or more biological samples potentially having mineralocorticoid, said chromatography system receiving one or more biological samples at a first time and separating the compounds in retained peaks comprising at least mineral corticoid retained peak for a mineralocorticoid in the event said mineralocorticoid is present at a mineralocorticoid retention time; and;
b. a mass spectrometer in fluid communication with said high performance liquid chromatography system to receive one or more of said retained peaks including said mineralocorticoid retained peak at said mineralocorticoid retention time, said mass spectrometer producing a signal in the presence of said mineralocorticoid at said retention time to allow said mineralocorticoid to be identified by retention peak and mass charge values.

2. The apparatus of claim 1 wherein said mineralocorticoid is aldosterone.

3. The apparatus of claim 1 further comprising data management means said data management means receiving said one or more mass charge values and retention times and identifying signals which correspond to said mineralocorticoid.

4. The apparatus of claim 3 wherein said data management system compares said signal identifying said mineralocorticoid with control values to determine a concentration said mineralocorticoid in said biological sample.

5. The apparatus of claim 4 wherein said data management system produces a warning signal indicating concentration values of mineralocorticoid in the biological sample which are outside normal values.

6. The apparatus of claim 5 wherein said warning signal is an indicator of primary aldosteronism.

7. The apparatus of claim 1 wherein said column has a packed media of 2-10 micron particles.

8. The apparatus of claim 7 wherein said particles have a carbon functionality.

9. The apparatus of claim 1 wherein said high pressure chromatography system is operated isocratically.

10. The apparatus of claim 9 wherein said high pressure chromatography system is operated with 30-40% acetonitrile in water.

11. The apparatus of claim 1 wherein said biological sample are spiked with a known amount of labelled mineralocorticoid derivative and said chromatography system produces a labelled mineralocorticoid peak.

12. The apparatus of claim 11 wherein said mineralocorticoid retained peak is compared to said labelled mineralocorticoid peak to allow the concentration of said retained mineralocorticoid to be compared to said labelled mineralocorticoid peak.

13. A kit for determining the concentration of mineralocorticoid in biological samples comprising labelled mineralocorticoid and instructions for the use of said labelled mineralocorticoid in a high performance liquid chromatography system and a mass spectrometer to determine the presence or absence of elevated levels of mineralocorticoid.

14. The kit of claim 13 wherein said mineralocorticoid is aldosterone.

15. The kit of claim 13 further comprising a column.

16. A method of determining the presence or absence of a mineralocorticoid in a biological sample comprising the steps of:
a. placing a biological sample in a high performance liquid chromatography system having a column for receiving one or more biological samples potentially having a mineralocorticoid, said chromatography system receiving said biological sample at a first time and separating the compounds in retained peaks comprising at least one mineralocorticoid retained peak for said mineralocorticoid in the event said mineralocorticoid is present at a mineralocorticoid retention time; and;
b. placing said at least one retained peak corresponding with a retention time for mineralocorticoid in a mass spectrometer in fluid communication with said high performance liquid chromatography system, said mass spectrometer receiving said at least one retained peak including said mineralocorticoid retained peak at said mineralocorticoid retention time if said mineralocorticoid is present in said biological sample, said mass spectrometer producing a signal in the presence of said mineralocorticoid at said retention time to allow said mineralocorticoid to be identified by retention peak and mass charge values.

17. The method of claim 16 wherein said mineralocorticoid is aldosterone.

18. The method claim 16 further wherein said signal is received by data management means said data management means receiving said one or more mass charge values and retention times and identifying signals which correspond to said mineralocorticoid.

19. The method of claim 18 wherein said data management system compares said signal identifying a mineralocorticoid with control values to determine a mineralocorticoid concentration in said biological sample.

20. The method of claim 18 further comprising the step of providing a derivative of said mineralocorticoid in said biological sample and said chromatography system to produce a labelled mineralocorticoid peak provide a control value.

21. The method of claim 20 wherein said mineralocorticoid retained peak is compared to said labelled mineralocorticoid peak to allow the concentration of said retained mineralocorticoid to be compared to said labelled mineralocorticoid peak.

22. The method of claim 19 wherein said data management system produces a warning signal indicating concentration values of mineralocorticoid in the biological sample which are outside normal values.

23. The method of claim 22 wherein said warning signal is an indicator of primary aldosteronism.

24. The method of claim 16 wherein said column has a packed media of 2-10 micron particles.

25. The method of claim 24 wherein said particles have a carbon functionality.

26. The method of claim 16 wherein said high pressure chromatography system is operated isocratically.

27. The method of claim 26 wherein said high pressure chromatography system is operated with 30-40% acetonitrile in water.
